(19) United States
(12) Patent Application Publication
(10) Pub. No.: US 2020/0107984 A1
(43) Pub. Date: Apr. 9, 2020

(54) Adjustable Surgical Chair

(71) Applicant: Boyd Industries, Inc., Clearwater, FL (US)

(72) Inventor: Jesse Knight, Clearwater, FL (US)

(73) Assignee: Boyd Industries, Inc., Clearwater, FL (US)

(21) Appl. No.: 16/596,348

(22) Filed: Oct. 8, 2019

Related U.S. Application Data
(60) Provisional application No. 62/742,757, filed on Oct. 8, 2018.

(51) Int. Cl. A61G 15/02

(52) U.S. Cl. CPC A61G 15/02; A61G 2200/34

(57) ABSTRACT

An adjustable chair for patients undergoing dental procedures comprising a seat, back and leg rest. The seat is attached to a base with rotating adjustable members and a screw rod is used raise the seat from a lowered position of about 18 inches to a height of about 43 inches, thereby allowing the person performing the procedure to select either a seated or standing position. Further screw rod assemblies permit the back to recline to 15 to 30 degrees and the leg rest to raise to a level that is substantially parallel with the seat.

### CROSS-REFERENCE TO RELATED APPLICATIONS

This application claims priority to Provisional application No. 62/742,757, filed Oct. 8, 2018, which is incorporated by reference herein in its entirety.

### FIELD OF THE INVENTION

The present invention relates to adjustable chairs and platforms on which a patient rests while surgery is being performed. Such chairs and platforms are useful in any environment where a person must be positioned vertically while in a reclining position for an extended period of time, often while a technician, dentist, doctor or surgeon performs procedures on that person.

The present invention provides for an electrically-driven, reclining surgical chair or platform with an extended range of motion that allows the technician, dentist, doctor or surgeon to elect to perform procedures from either a sitting position or a standing position. The enhanced range of motion may help avoid back and neck strain for the person performing the procedure (by allowing them to change positions during or between procedures), which in turn may allow them to perform more procedures in a given day.

The present invention may also provide a more reliable design that may be installed more easily and in more restricted spaces. Other features of the present invention will be apparent to those of ordinary skill in the art in light of this disclosure.

### BACKGROUND OF THE INVENTION

The present invention relates to adjustable chairs and platforms on which a patient rests while surgery is being performed. Such chairs and platforms are useful in any environment where a person must be positioned vertically while in a reclining position for an extended period of time, often while a technician, dentist, doctor or surgeon performs procedures on that person.

The present invention provides for an electrically-driven, reclining surgical chair or platform with an extended range of motion that allows the technician, dentist, doctor or surgeon to elect to perform procedures from either a sitting position or a standing position. The enhanced range of motion may help avoid back and neck strain for the person performing the procedure (by allowing them to change positions during or between procedures), which in turn may allow them to perform more procedures in a given day.

The present invention may also provide a more reliable design that may be installed more easily and in more restricted spaces. Other features of the present invention will be apparent to those of ordinary skill in the art in light of this disclosure.

### SUMMARY OF THE INVENTION

The disclosed apparatus has an adjusting support assembly between a seat and a base plate, or other supporting floor or platform. A reclining back is positioned on or proximate to a rearward side of the seat and an adjustable leg support is positioned on or proximate to the opposed forward side of the seat. A reversible back motor is adapted to turn a back screw rod affixed in a hinged relationship to the back, and a reversible leg-support motor is adapted to turn a leg support screw rod affixed in a hinged relationship to the leg support. A reversible seat motor is affixed in a hinged relationship between the seat and the adjusting support assembly. The adjusting support assembly is adapted to enable the seat to be adjusted in height such that a person performing a procedure may choose to do so from a seated position or from a standing position.

### BRIEF DESCRIPTION OF THE DRAWINGS

Other features in the invention disclosed herein will become apparent from the attached drawings, which illustrate certain preferred embodiments of certain apparatuses and their component parts, wherein:

FIG. 1 is a side view of an embodiment of an adjustable platform apparatus according to the present disclosure, with coverings and padding removed to expose certain internal components, and the apparatus in a fully-lowered configuration;

FIG. 2 is an orthogonal view of the embodiment of FIG. 1 with shrouds attached showing the apparatus in a partially raised configuration;

FIG. 3 is a side view of the embodiment of FIG. 1 with shrouds attached showing the apparatus in a fully raised configuration;

FIG. 4 is an orthogonal view of a base plate, adjusting support assembly and seat motor assembly suitable for use with embodiments of an adjustable platform apparatus as described herein;

FIG. 5 is a top view of the embodiment of FIG. 1 with seat padding and seat base removed to show internal components; and

FIG. 6 is a cutaway, orthogonal view of the embodiment of FIG. 1 in a lowered configuration showing internal components and shroud configuration.

FIG. 7. is side view of an embodiment of seat shroud pre-assembled.

FIG. 8 is a side, bottom view of an embodiment of an adjustable chair with exterior seat shroud installed.

FIG. 9 is a side, bottom view of an embodiment of an adjustable chair showing placement for internal shroud installation.

FIG. 10 is a side view of a portion of an embodiment of an adjustable chair showing placement of a front shroud on a central arm linkage.

FIG. 11 is a side view of a portion of an embodiment of an adjustable chair showing placement of a rear shroud on a central arm linkage.

FIG. 12 is a side view of an embodiment of an adjustable chair showing recess cuts and wells in a rear shroud.

FIG. 13 is a side view of a portion of an embodiment of an adjustable chair showing motor clearance at high position in a rear shroud.

FIG. 14 is a side view of a base portion of an embodiment of an adjustable chair showing placement of a base shroud.

FIG. 15 is side view of an embodiment of an adjustable chair showing nesting shrouds when the chair is at the lowest position.

FIG. 16 are side views of an embodiment of an adjustable chair showing shrouds at the highest raised position, a partially raised position, and the lowest position

FIG. 17 are side views of an embodiment of an adjustable chair at a partially raised position.

### DETAILED DESCRIPTION

While the following describes preferred embodiments of an adjustable chair according to the present invention, it is understood that this description is to be considered only as illustrative of the principles of the invention(s) described herein and is not to be limitative thereof. Numerous other variations, all within the scope of the claims, will readily occur to those of ordinary skill in the art.

In the following description, details are set forth for purpose of explanation. However, one of ordinary skill in the art will realize that the embodiments described herein may be practiced without the use of all of these specific details. The embodiments (and descriptions) disclosed herein are intended, therefore, to be illustrative only, and not limiting. Similarly, where examples are used herein, the examples are not intended to be limiting unless the context in which the example is used clearly indicates otherwise. Accordingly, “for example” or “e.g.” should be read as “for example, and without limitation.” unless the context indicates that limitation to the given example(s) is intended.

Herein, “adapted” means configured, sized, positioned and arranged as appropriate to render an item suitable for use with another apparatus. “Adapted” is intended herein as a description of structure, and not as a description of function.

The term “adjustable chair” or “surgical chair” herein means a platform capable of supporting a human being and being adjusted to different heights. Whereas embodiments of such platforms will typically allow the human to be in a seated or reclining position, such features may not always be necessary for all embodiments. While adjustable chairs similar to the embodiments described herein are often used for dental procedures, those of skill in the art will recognize that such adjustable chairs may also have applicability in other fields in which a person or apparatus performs procedures on a patient and the ability to adjust the height of the patient for or during the procedure may be advantageous.

The meaning of other terms may be defined herein or will otherwise be apparent to those of ordinary skill as the ordinary meanings used in the art of dental or surgical chair or platform design.

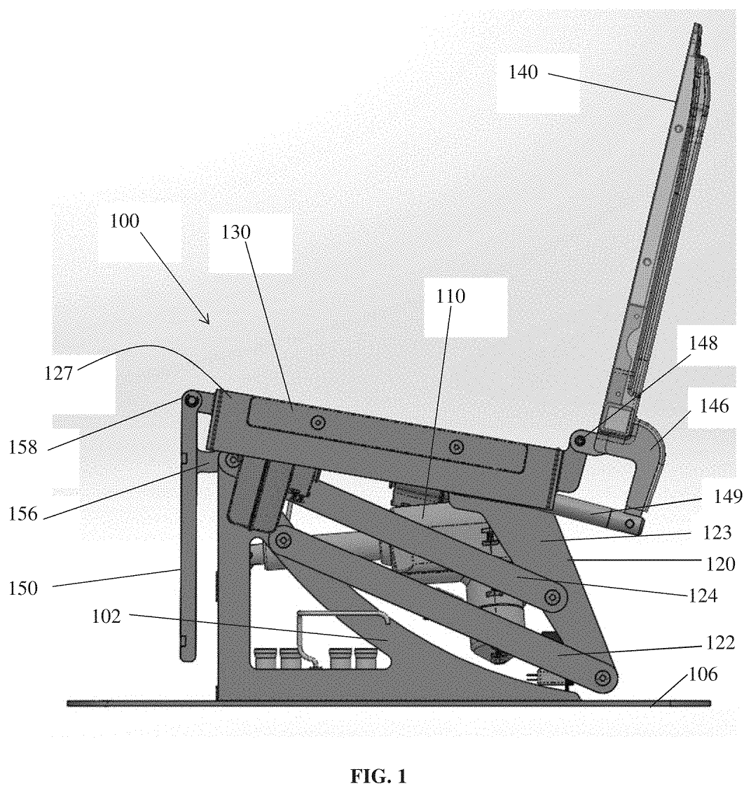

Referring to FIG. 1, an embodiment of an adjustable chair 100 is shown, with shrouds, pads, coverings and other components removed so as to expose certain internal components. Adjustable chair 100 has seat 130, back 140 and leg support 150. Back 140 is attached to seat 130 at back hinges 148, which are adapted to allow back 140 to rotate in an increasingly reclining position. In certain embodiments, back hinges 148 will be adapted to enable back 140 to adjust from perpendicular to seat 130 to a fully reclined position that is parallel with seat 130. Narrower ranges of motion, however, may be suitable depending on the application.

Similarly, leg support 150 is attached to the opposed forward end of seat 130 at leg support hinges 158, which are adapted to enable leg support 150 to rotate from a downward-pointing position (as shown in FIG. 1) to a more horizontal position. In certain embodiments, leg support hinges 158 will be adapted to enable leg support 150 to adjust to a position in which leg support 150 is parallel with seat 130. However, as with back 140, narrower ranges of motion may be suitable depending on the application.

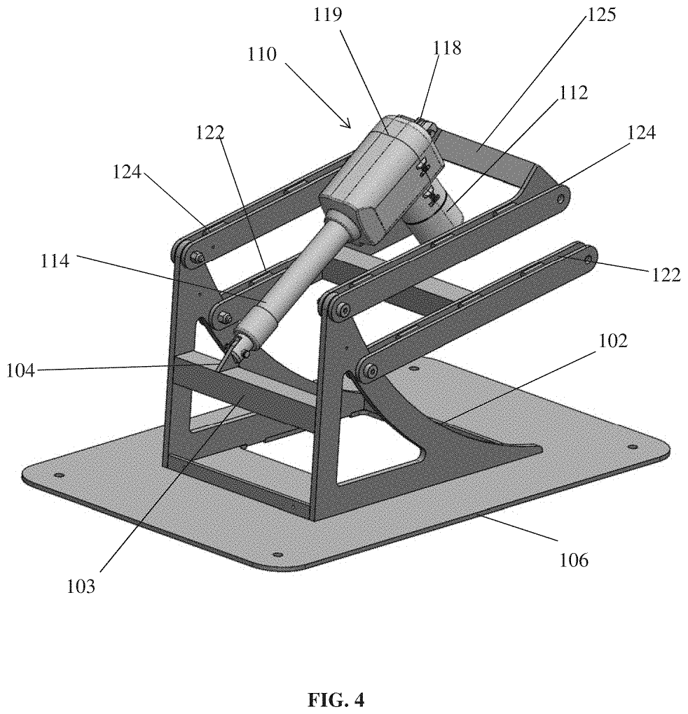

Adjusting support assembly 120 (described further below in connection with FIG. 4) is affixed to seat 130 and to base plate 106. Base plate 106 is adapted to be affixed to a floor or support platform in a manner that gives stability to adjustable chair 100. Where further adjustability is desirable, base plate 106 may be affixed to a rotating platform (not illustrated) that would allow adjustable chair 100 to rotate, similar to the operation of a lazy Susan. As is discussed further below, adjusting support assembly 120 comprises fixed base support 102 and fixed seat support 123, connected by adjusting lower adjusting member 122 and upper adjusting member 124. Seat motor assembly 110 connects fixed base support 102 to brackets 127 attached or integral to seat 130. This arrangement allows seat 130 to be raised from the fully lowered position shown in FIG. 1 by seat motor assembly 110, as is described further below.

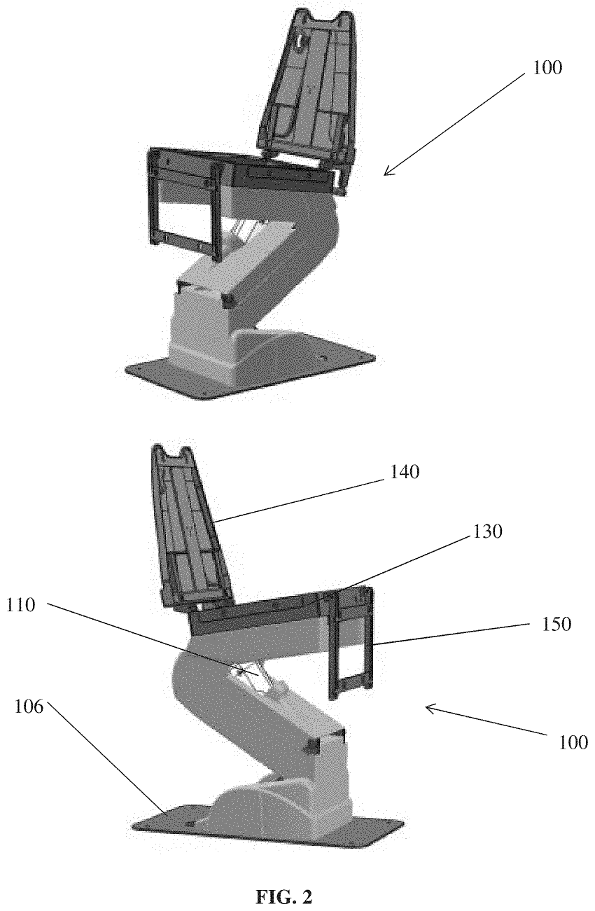

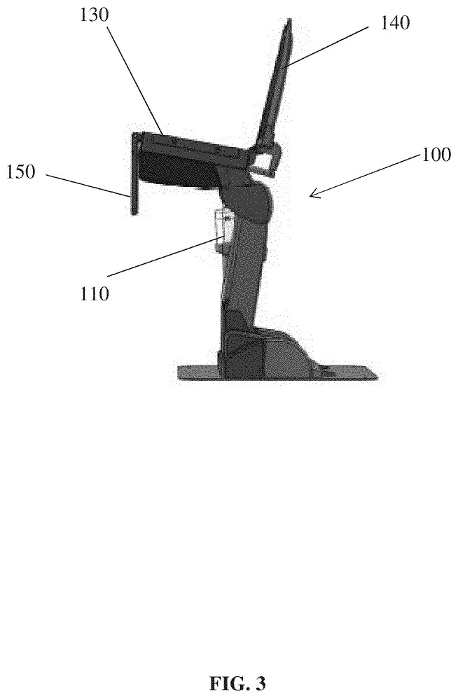

Referring to FIGS. 2 and 3, adjustable chair 100 is shown in a partially-raised and fully-raised configuration, respectively. As illustrated in, for example, FIGS. 2 and 3 shrouds are attached to an adjustable chair both to hide internal components for aesthetic reasons, and to protect such components from dirt, dust, spills, and minor physical damage for functional reasons. While base plate 106 is illustrated, it will be understood that it is optional and that fixed base support may be affixed directly to the floor or to an intermediary platform if so desired. In the illustrated embodiment, base plate 106 provides stability by spreading loads asserted by adjustable chair 100 over a larger area of a floor or supporting platform (not illustrated).

Referring now to FIG. 4, adjusting support assembly 120 (as depicted in FIG. 1), seat motor assembly 110, and base plate 106 are illustrated in greater detail. Lower adjusting members 122 and upper adjusting members 124 are on either side of, and rotably attached to, fixed base support 102, which is, in turn, fixedly attached to base plate 106. Where base plate 106 and fixed base support 102 is made from a metal such as steel, the attachment may conveniently be by welding. Alternatively, the attachment may be mechanical connectors or by adapting fixed base support 102 to have a portion (not shown) overlapped and sandwiched in place base plate 106.

Front cross member 103 adds further support to the two sides of fixed base support 102, and provides attachment tab 104 for seat motor assembly 110. Lower adjusting members 122 and upper adjusting members 124 are then rotably attached to fixed seat support 123 as shown in FIG. 1. Lower adjusting members 122 and upper adjusting members 124 may conveniently be formed of separated sections of metal or another rigid material with points at either end for rotable attachment. Because lower adjusting members 122 and upper adjusting members 124 have constrained lengths and are attached to fixed base support 102, they will rotate upward when urged away from front cross member 103, thereby raising seat 130.

The urging away may be accomplished by seat motor assembly 110, which is rotably connected between attachment tab 104 and back cross member 125. Seat motor 112 may conveniently be an AC or DC electric motor operably attached to gear assembly (not shown) in gear housing 119. After translating the rotational motion of seat motor 112 approximately ninety degrees, and optionally using a suitable gear reduction ratio, a seat screw rod (not illustrated) within seat screw rod housing 114 is turned. With screw rod housing 114 attached to the screw rod with a threaded coupling (not shown) rotation of seat motor 112 is translated into a linear motion that urges back cross member 125 away from front cross member 103 (causing seat 130 to raise) when seat motor 112 is operated in a first direction, and urges back cross member 125 closer to front cross member 103 (thereby lowering seat 130) when seat motor 112 is operated in a reverse, second position. For this reason, it is seen that seat motor 112 is preferably reversible.

Whereas hydraulics may also be used to create adjustable chairs, the present embodiments use electric motors instead. The combination of electric motors and screw rods may be more reliable in certain embodiments, allow for a greater range of motion than hydraulics of comparable size, and do not risk spillage of hydraulic fluids. In the illustrated embodiment, the range of vertical motion of seat 130 may conveniently adjust seat 130 from an entry/egress height of 17-19 inches above the floor to a high point of 42.5 inches. That vertical range may allow a dentist, technician, doctor or surgeon to perform a procedure when seated, or when standing, by adjusting the height of seat 130. The use of electric motors may also create a more compact and simpler installation by eliminating the need for separate hydraulic pumps or reservoirs. While the illustrated embodiment shows the use of electric motors, however, this is not to be interpreted to preclude the use of hydraulic or pneumatic actuating mechanisms except to the extent such a limitation is expressly included in the claims. It will thus be understood that while the term seat motor assembly is described herein as an electrically driven assembly, unless otherwise limited by the claims, it may also be a hydraulically or pneumatically driven assembly.

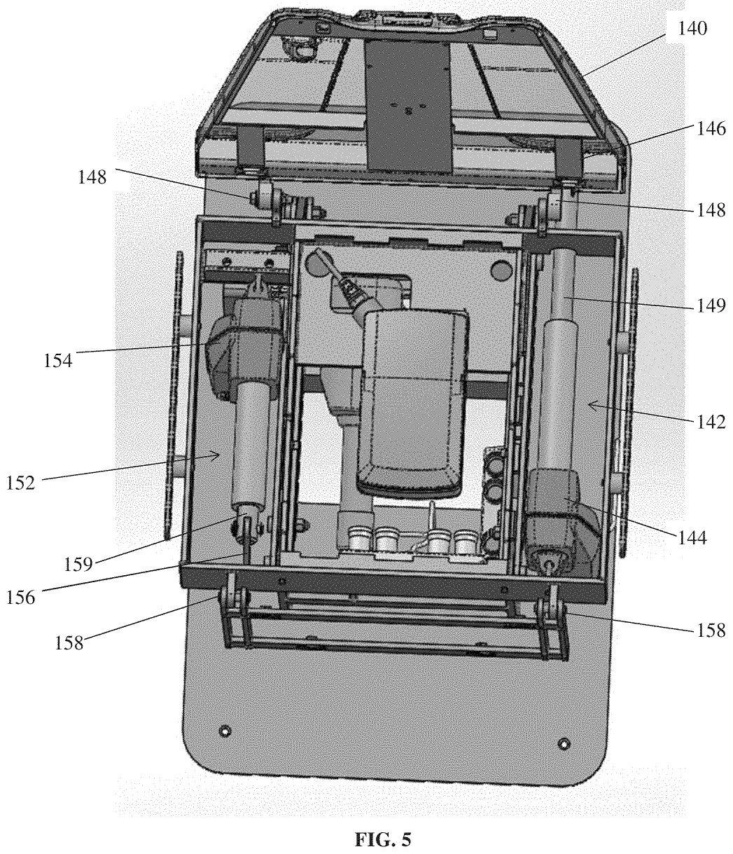

Referring to FIG. 5, an internal view of the components underlying seat 130 is shown, with some components removed for visibility. Back motor assembly 142 is operably attached to back tabs 146. Back hinges 148 rotably attach back 140 such that when back tabs 146 are moved, back 140 tilts by rotation about back hinges 148. Back motor assembly 142 has back motor 144 which may conveniently be a reversible AC or DC motor operably attached (in line or through a reduction gear (not shown)) to an internal back screw rod (not shown). When back motor 144 rotates, the internal back screw rod urges back screw rod housing 149 toward or away from back motor 144, depending on the direction of rotation. This substantially linear motion is translated into a tilting motion for back 140 about back hinges 148.

As illustrated in FIG. 5, seat 130 is positioned at an incline of about fifteen degrees from the horizontal. Tilting back 140 to its full extension such that it is parallel to seat 130 would thus place the head of person at a low position within the range of what is known as the Trendelenburg position. Such recline may be extended further if desired, but it may be uncomfortable for some persons to have back 140 extend beyond a parallel orientation.

Similarly, leg support motor assembly 152 is attached to leg support tab 156, which is, in turn, connected to leg support 150 (as shown in FIG. 1). When leg support tab 156 is urged outward, leg support 150 rotates about leg support hinge 158. In certain embodiments, total rotation of leg support 150 may exceed ninety degrees, thereby allowing a person in adjustable chair 100 to have their knees fully bent such that their feet are flat on the floor, or fully extended such that their legs are straight.

The urging of leg support tab 156 may be accomplished by reversible leg support motor 154 which may conveniently be an AC or DC electric motor connected in line, either directly or through a reduction gear (not shown) to an internal leg support screw rod (not shown). Leg support screw rod housing 159 is operably connected to the internal screw rod in a threaded configuration such that rotation of the internal screw rod is translated into linear motion of leg support screw rod housing 159. In this way, leg support 150 may be raised or lowered by operating leg support motor 154 in one direction or the other.

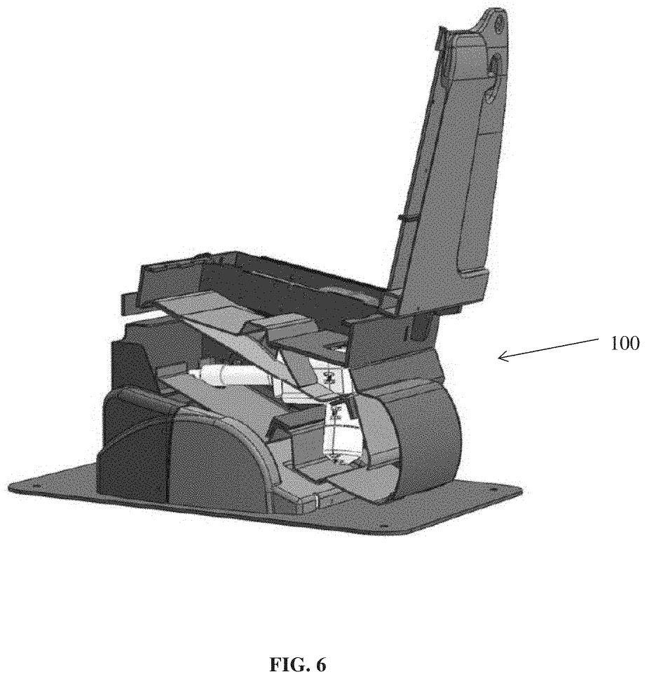

Referring to FIG. 6, a cut away view of adjustable chair 100 is shown, with shrouds covering certain internal components. The shrouds may conveniently be formed of molded plastic suitable for use in a medical environment and serve both aesthetic and functional purposes. Aesthetically, the shrouds create a more pleasing appearance and can be interchanged with shrouds of different colored material to match a given color scheme or preference. Functionally, they help shield internal components from dust, spillage, and other contaminants, and help protect such components from physical damage.

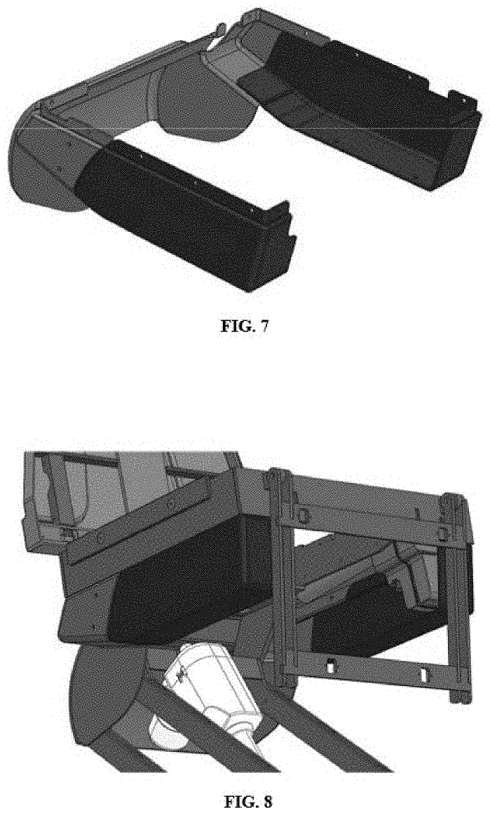

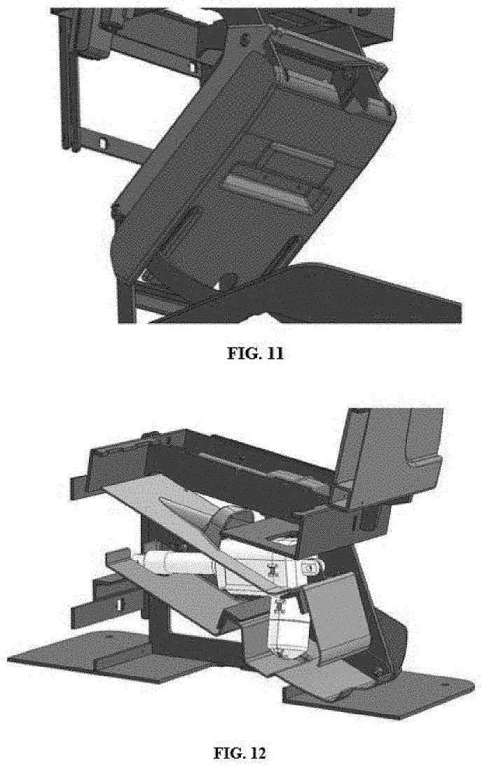

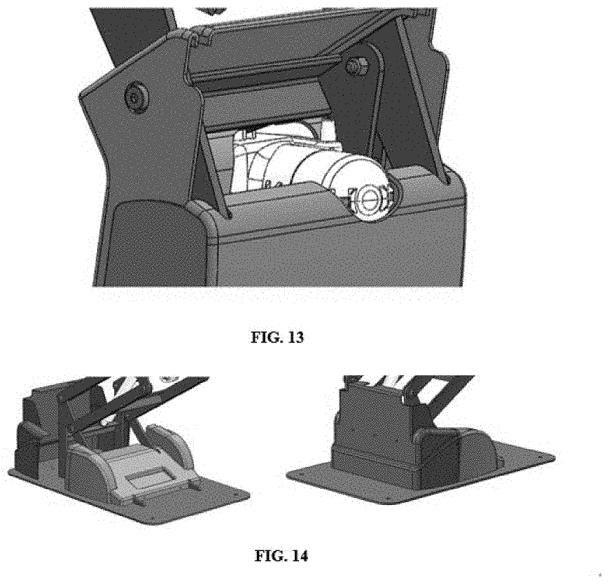

FIGS. 7-15 describe eight thermal-formed plastic shrouds suitable for use in various embodiments of an adjustable chair according to the foregoing detailed description. The shrouds may be formed of a variety of materials, one suitable material being 0.125″ Kydex® or equivalent.

As illustrated in FIGS. 7-9, there are four main panels which shroud the seat base: a rear shroud, left and right shrouds, and an internal cover. The rear, left and right shrouds can be pre-assembled together. When assembled, the three parts form a lip which sits within the perimeter of the outer walls of the seat base weldment. The lip has a series of holes through which attachment hardware may be installed, including attachment with a ¼″ fastener which may be a rivet, screw, etc. Once installed, an internal cover can he added which can sit within openings on the left and right shrouds and can attach to them via a fastener fed through the aligned holes. In this particular embodiment, there is a clearance section for the main motor which provides three more mounting locations so that the internal seat shroud can attach to the seat base. There are also several clearance cuts on the seat base shroud for the seat motor, leg rest motor and back motor.

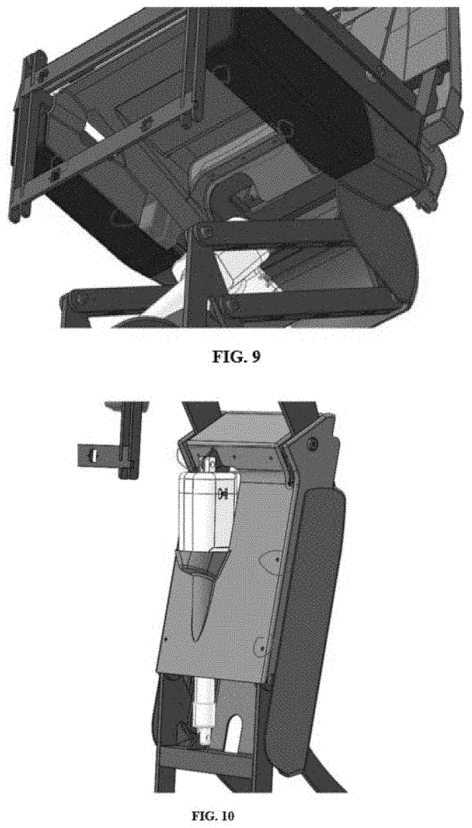

As shown FIGS. 10-13, in certain particular embodiments there are two shrouds which cover the central arm linkage: a rear shroud and a front shroud. The front shroud nests within the rear shroud so that at mid-position, when the arm linkage is at its widest, the linkage remained hidden. The front shroud attaches to the linkage at three locations: central, near where the seat motor is mounted, and two sets along the sides which may be able to tap into the spacers on the arm linkage. The rear shroud attaches via the central well, tying to the cross bar in the bottom linkage. Other attachment points may be desirable to further secure the shroud based on materials used, range of motion, and configuration of components. There also can be several clearance cuts and wells added for the motors and linkage arms.

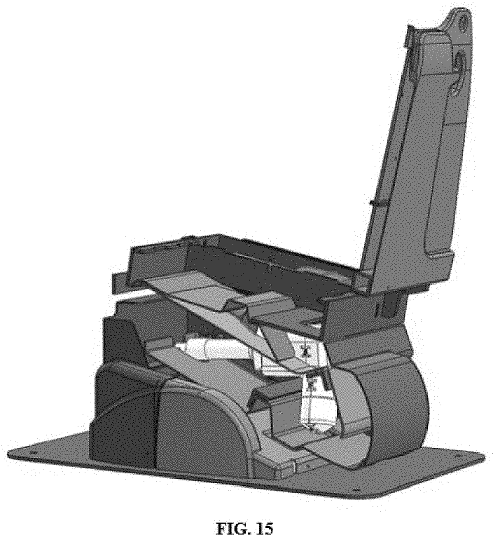

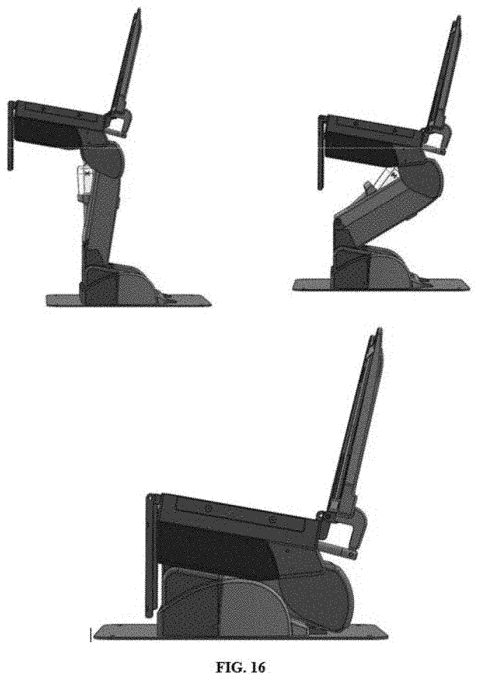

As shown in FIGS. 14 and 15, in certain particular embodiments of an adjustable chair, two shrouds can close around the base of the assembly from the front and rear. They nest together to form a continuous surface thanks to a recessed lip on the rear shroud. The rear shroud can tap into the small cross member running transverse across the base plate, while the front shroud may tap into the cross member at the front. The two pieces can tie together on each side via a fastener through the aligned holes. There can also be are several clearance cuts and wells added for the motor shaft, linkage arms, and base arms.

FIG. 16 shows shrouds in a particular embodiments of an adjustable chair at three different raised positions and the placement of the shrouds at those various positions (highest, partially raised, lowest).

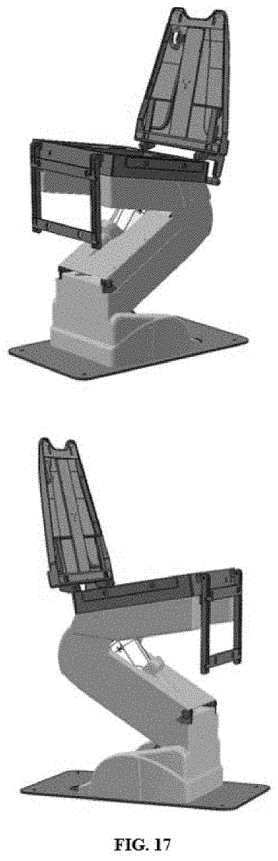

While a variety of configurations and hardware may be used for the seat motor assembly, back motor assembly, and leg rest motor assembly, the following products and accessories can be used in the specific embodiments of the adjustable chair, including the embodiment shown in FIG. 17: Seat Motor (LA34 series actuator, maximum thrust in push: 10.000 N. Stroke length: 150 mm, installation dimension: 360 mm. Hall feedback, 24 v. motor, safety nut in push); Back Motor (LA 40 series actuator, maximum thrust in push: 6,000 N, stroke length: 175 mm, installation dimension: 345 mm, dual encoded Hall feedback, slot rod eye and back fixture, safety nut in push); Leg Rest Motor (LA 40 series actuator, maximum thrust in push: 4,000 N, stroke length: 130 mm, installation dimension: 300 mm, dual encoded Hall feedback, back fixture with slot 10.2 mm, safety nut in push); Accessories (Control box 1 (# C06+09421X09000): 200 W universal SMPS, Control box 2 (# C07+19431X29000): 350 W Power, 4 channel, IP66 Washable Dura, Bluetooth® hardware ready, Full H bridge can run all channels simultaneously, buzzer included, Communication box for foot control: # DJB0002002-1025), and Other (motor cables, cable locks, buzzer, battery mounting kit for control box. AC power cable). All of the products and accessories described above were available at least as of the date of this application from LINAK U.S., Inc. of Louisville, Ky. It will be understood that the foregoing motor assemblies may be controlled by a variety of external switches to adjust seat height, leg test angle, and back angle, including (without limitation) foot controls and handheld wired controls. Bluetooth® wireless control via a phone, tablet, computer, or similar device may also be preferable in some environments. Further, it will be understood that such specifics are for illustrative and exemplary purposes only and are not intended to be limiting.

The foregoing description includes certain embodiments. Those of skill in the art will readily see variations and improvements that may be included in alternate embodiments in light of this disclosure. The invention described herein is not intended to be limited to the embodiments discussed in the detailed description or shown in the figures.

What is claimed:

1. An adjustable chair apparatus comprising
a seat having a back rotably attached proximate to a seat back end and a leg support rotably attached to an opposed seat front end;
said seat being attached to an adjustable support assembly comprising at least one adjusting member on each side, rotably attached to a fixed base support on one end and rotably attached to a fixed seat support on the opposed end;
said adjustable chair apparatus further comprising a seat motor assembly attached between said fixed base support and said fixed seat support, and comprising a seat motor operably connected to a perpendicular screw rod through a gear assembly, and a seat screw rod housing attached to said screw rod such that rotation of said screw rod urges said screw rod housing in a linear motion wherein said seat motor is a reversible electric motor
whereby operation of said seat motor in one direction will cause said seat to raise, and operation of said seat motor in the opposite direction will cause said seat to lower.

2. The adjustable chair apparatus of claim 1 further comprising a back motor assembly operably attached to said back by a screw rod attached to a tab attached to said back such that operation of the back motor assembly in one direction causes said back to recline.

3. The adjustable chair apparatus of claim 2 wherein said back motor assembly comprises a back motor that is a reversible electric motor.

4. The adjustable chair apparatus of claim 1 further comprising a leg support motor assembly operably attached to said leg support by a screw rod such that operation of the leg support motor assembly in one direction causes said leg support to raise, and operation of said leg support motor assembly in the other direction causes said leg support to lower.

5. The adjustable chair apparatus of claim 4 wherein said seat motor assembly comprises a seat motor that is a reversible electric motor.

6. The adjustable chair apparatus of claim 1 wherein said seat motor assembly is adapted to raise said seat from an initial position of about 18 inches to a height of about 43 inches.

7. The adjustable chair apparatus of claim 2 wherein said back motor assembly is adapted to recline to the point where a patient in said adjustable chair apparatus would have their head at the lowest part of their body with a decline of 15 degrees to 30 degrees.

8. The adjustable chair apparatus of claim 1 further comprising a base plate.

9. An adjustable chair apparatus comprising
a seat having a back rotably attached proximate to a seat back end and a leg support rotably attached to an opposed seat front end;
said seat being attached to an adjusting support assembly comprising at least one adjusting member on each side, rotably attached to a fixed base support on one end and rotably attached to a fixed seat support on the opposed end;
said adjustable chair apparatus further comprising a seat motor assembly attached between said fixed base support and said fixed seat support, and comprising a seat motor operably connected to a perpendicular screw rod through a gear assembly, and a seat screw rod housing attached to said screw rod such that rotation of said screw rod urges said screw rod housing in a linear motion
whereby operation of said seat motor in one direction will cause said seat to raise, and operation of said seat motor in the opposite direction will cause said seat to lower;
wherein said seat motor assembly is adapted to raise said seat from an initial position of about 18 inches to a height of about 43 inches.

10. The adjustable chair apparatus of claim 9 further comprising a back motor assembly operably attached to said back by a screw rod attached to a tab attached to said back such that operation of the back motor assembly in one direction causes said back to recline.

11. The adjustable chair apparatus of claim 9 wherein said seat motor is a reversible electric motor.

12. The adjustable chair apparatus of claim 10 wherein said back motor assembly comprises a back motor that is a reversible electric motor.

13. The adjustable chair apparatus of claim 9 further comprising a leg support motor assembly operably attached to said leg support by a screw rod such that operation of the leg support motor assembly in one direction causes said leg support to raise, and operation of said leg support motor assembly in the other direction causes said leg support to lower.

14. The adjustable chair apparatus of claim 14 wherein said leg motor assembly comprises a seat leg motor that is a reversible electric motor.

15. The adjustable chair apparatus of claim 10 wherein said back motor assembly is adapted to recline to the point where a patient in said adjustable chair apparatus would have their head at the lowest part of their body with a decline of 15 degrees to 30 degrees.

16. The adjustable chair apparatus of claim 9 further comprising a base plate.
